(19) United States
(12) Patent Application Publication
(10) Pub. No.: US 2025/0147547 A1
(43) Pub. Date: May 8, 2025

(54) DEVICE PACKAGING CHARGING STATION

(71) Applicant: Meta Platforms Technologies, LLC, Menlo Park, CA (US)

(72) Inventor: Vinod Kannan, Redmond, WA (US)

(21) Appl. No.: 18/795,373

(22) Filed: Aug. 6, 2024

Related U.S. Application Data
(60) Provisional application No. 63/597,169, filed on Nov. 8, 2023.

(51) Int. Cl. G06F 1/16; H02J 7/00

(52) U.S. Cl. CPC G06F 1/1632; G06F 1/163; H02J 7/0045

(57) ABSTRACT

A package charging station is disclosed. The packaging charging station may include an outer portion, an inner portion, a receiving portion, and a connecting portion. The inner portion may include a molding corresponding to an artificial reality device. The receiving portion may be included in the molding at a position corresponding to a charging port of the artificial reality device. The connecting portion may be included in the outer portion and may be configured to connect to external power for charging the artificial reality device when the artificial reality device is placed in the inner portion.

### CROSS-REFERENCES TO RELATED APPLICATIONS

The present disclosure is related and claims priority, under 35 U.S.C. § 119(e), to U.S. Provisional Patent Application No. 63/597,169, entitled “DEVICE PACKAGING CHARGING STATION” to Vinod Kannan, filed on Nov. 8, 2023, the contents of which are hereby incorporated by reference in their entirety, for all purposes.

### TECHNICAL FIELD

The present disclosure generally relates to consumer devices, and more particularly to device charging integrated with device packaging.

### BACKGROUND

User experience may be significantly influenced by the convenience and reliability of device charging solutions. Traditional charging methods for artificial reality devices (e.g., for mixed reality, virtual reality, etc.) may often involve separate charging stations or docks, which can be cumbersome and expensive. These stations are typically sold separately from the devices, adding to the overall cost for the consumer. Moreover, the design of these devices sometimes makes it challenging to charge them without a dedicated station, leading to potential damage or wear during the charging process. The need for a protective and efficient charging solution may be evident in the market, as users seek to maintain their devices in optimal condition while ensuring they are charged and ready for use.

### BRIEF SUMMARY

The subject disclosure provides for device packaging charging stations and related kits and methods. A user is allowed to conveniently charge their artificial reality devices using the device's original packaging, which has been modified to function as a charging station. For example, the packaging includes a molding that corresponds to the shape of the artificial reality device and a connecting portion for power, allowing the device to be charged while securely housed within its packaging.

One aspect of the disclosure relates to a package charging station configured for charging an artificial reality device. The package charging station may include an outer portion. The package charging station may include an inner portion with a molding corresponding to the artificial reality device. The package charging station may include a receiving portion that is included in the molding at a position corresponding to a charging port of the artificial reality device. The package charging station may include a connecting portion that is included in the outer portion and is configured to connect to power for charging the artificial reality device when the artificial reality device is placed in the inner portion.

Another aspect of the disclosure relates to a package modification kit configured to modify packaging for an artificial reality device to add charging station functionality. The package modification kit may include a magnetic receiver wherein a port of the receiver is attachable to a charging connector or port of an artificial reality device. The package modification kit may include a magnetic charging cable that is magnetically attachable to a magnetic tip of the magnetic receiver. The package modification kit may include an attachment for connecting the magnetic receiver to a packaging of the artificial reality device.

Yet another aspect of the disclosure relates to a method for manufacturing a device packaging charging station. The method may include providing an outer portion configured to act as packaging for an artificial reality device. The method may include forming an inner portion including a molding corresponding to the artificial reality device, wherein the molding is configured to be held within the outer portion. The method may include integrating a receiving portion into the molding at a position corresponding to a charging port of the artificial reality device. The method may include attaching a connecting portion to the outer portion, wherein the connecting portion is configured to connect to a power source. The method may include configuring the connecting portion to enable charging of the artificial reality device when the artificial reality device is placed within the inner portion.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIGS. 1A-1B illustrate an exemplary inner packaging of an artificial reality device package for an artificial reality headset, in accordance with one or more implementations.

FIGS. 2A-2B illustrate an exemplary side-view illustration of an artificial reality headset packaging, in accordance with one or more implementations.

FIGS. 3A-3B illustrate a top view of the artificial reality headset packaging of FIG. 1, in accordance with one or more implementations.

FIGS. 4A-4B illustrate an example magnetic connector-based charging station, in accordance with one or more implementations.

FIGS. 5A and 5B illustrate an example artificial reality device packaging with and without an artificial reality headset connected to a magnetic connector-based charging station, respectively, in accordance with one or more implementations.

FIG. 6 illustrates a magnetic cable design used as part of a magnetic connector-based charging station, in accordance with one or more implementations.

FIGS. 7A and 7B illustrate an exemplary magnetic charger design, in accordance with one or more implementations.

FIG. 8 illustrates an example method for manufacturing a device packaging charging station, in accordance with one or more implementations.

FIG. 9 is a block diagram illustrating an example computer system (e.g., representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

Conventionally, artificial reality is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality.

In some artificial reality systems, users may frequently encounter difficulties with charging their equipment. The absence of a charging station included with the purchase of the equipment may necessitate additional expenses and often results in inconvenient and awkward charging setups. This may lead to improper charging habits and potential damage to the equipment, which are typically high-value items requiring careful handling. Furthermore, the environmental impact of packaging waste is a growing concern, as most packaging may be discarded after serving its initial purpose of protecting the equipment during transport. There is a clear need for a more cost-effective, convenient, and environmentally friendly charging solution for artificial reality systems that also addresses the issue of equipment protection during charging.

Implementations described herein address the aforementioned shortcomings and other shortcomings by providing a charging station integrated into the packaging of artificial reality devices. This package charging station may include an outer portion, typically the box or packaging of the device, and an inner portion with a molding that corresponds to the shape of the device. The inner molding may feature a receiving portion positioned to align with the device's charging port. Additionally, the outer portion may be equipped with a connecting portion designed to connect to a power source, enabling the device to charge when placed within the inner molding.

This approach not only offers a cost-efficient charging solution but also promotes sustainability by repurposing the device's packaging. The packaging, which would conventionally be discarded, is instead transformed into a functional charging dock that provides protection and stability for the device during charging. The design is versatile, accommodating various types of charging connectors, such as USB-C, lightning, or Micro-USB, and can include features like magnetic connectors for ease of use. By leveraging the existing packaging materials and design, some implementations may minimize additional manufacturing costs and environmental impact, providing a practical and eco-friendly charging solution for artificial reality device users.

According to some implementations, a package charging station is designed to integrate seamlessly with the packaging of artificial reality devices, transforming it into a functional out-of-box charging solution. The outer portion of the charging station, typically the original box or packaging of the artificial reality device, serves as the structural foundation. It may include a cover or lid and is configured to house and secure the inner portion, which includes a molding that precisely corresponds to the shape of the artificial reality device. This molding is crafted from durable materials such as plastic, metal, or composite materials, which not only provide a secure fit but also protect the device during charging.

The inner portion is further designed with a contoured surface that aligns with specific features of the device, ensuring stability and support. Within this inner molding lies the receiving portion, strategically positioned to align with the device's charging port. This receiving portion can take various forms, including a pogo pin receiver or a female USB-C port, and may be equipped with an indicator to display the charging status of the device.

The outer portion of the package charging station may include a connecting portion that allows for the connection to an external power source. This connecting portion is versatile, accommodating different types of connectors such as USB-C, lightning, or Micro-USB. For added convenience, the station may feature a magnetic connector that facilitates easy attachment and detachment, enhancing the user's interaction with the charging process.

A cable may be provided to link the charging station to a power source, with one end connected to the power source and the other end interfacing with the outer portion through the connecting portion. This cable may be connected to an adapter or charging block that plugs into the power source. In some designs, the cable is a magnetic charging cable with a magnetic tip, which simplifies the connection process by magnetically securing to the receiving portion.

To further augment the charging station's functionality, a package modification kit may be available. This kit may include a magnetic receiver that attaches to the device's charging port, a magnetic charging cable that connects to the magnetic receiver, and attachment means for securing the magnetic receiver to the packaging. This kit may enable users to convert existing packaging into a charging station or add charging capabilities to existing artificial reality device stands or accessories.

The charging station's design emphasizes sustainability by encouraging the reuse of packaging, thereby reducing waste and environmental impact. It leverages existing packaging materials to minimize additional manufacturing costs and environmental footprint. The station is also designed to be versatile and compatible with various artificial reality device models and brands, as well as other accessories associated with artificial reality devices.

User experience may be enhanced through features that promote organized and efficient charging. The inner portion may include a recessed area to hold the device in a predetermined orientation, and the connecting portion may comprise a retractable mechanism to store the cable neatly when not in use. These features contribute to a tidy and user-friendly charging environment.

From a manufacturing and implementation perspective, the package charging station can be implemented with minimal modifications to existing packaging, offering a low incremental cost solution for device manufacturers. The packaging can be modified using a simple package modification kit for users who already own artificial reality devices, making it a practical and user-oriented innovation.

Aspects of the subject matter described in this disclosure can be implemented to realize one or more of the following potential advantages. The described techniques may be implemented to support the dual functionality of packaging as both a protective container during shipping and a convenient charging station post-unboxing, which may reduce the need for additional accessories. The integration of charging capabilities within the packaging may lead to a reduction in electronic waste by repurposing materials that would otherwise be discarded. The use of magnetic connectors may simplify the charging process, potentially reducing wear on the device's charging port by minimizing the need for repeated physical connections. The design may allow for compatibility with various power sources and device models, which may enhance the versatility and appeal of the packaging to a broader range of users. The inclusion of status indicators and cable management systems may provide a more intuitive and clutter-free charging experience, potentially increasing user satisfaction with the overall product.

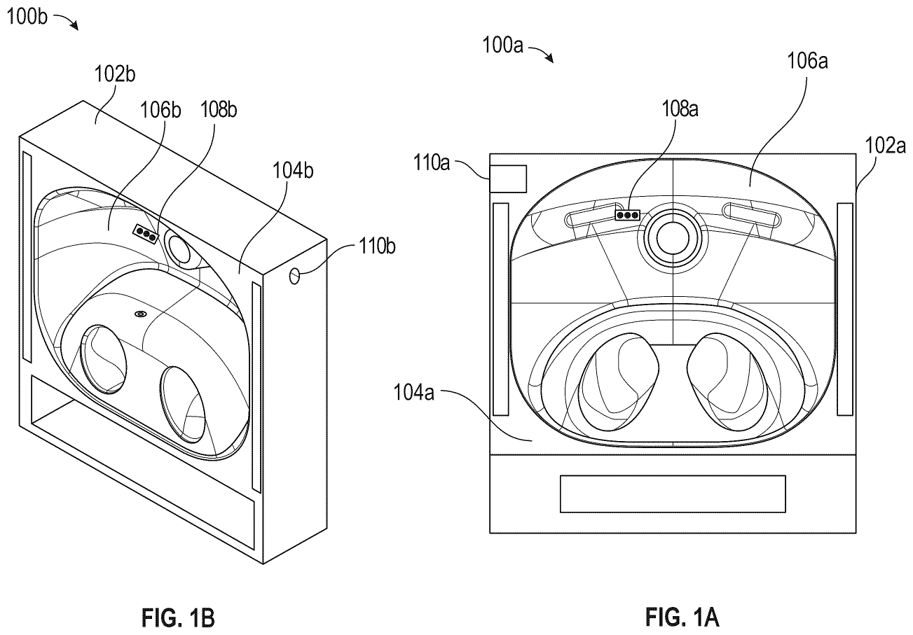

FIGS. 1A-1B illustrate an exemplary inner packaging of an artificial reality device package for an artificial reality headset, in accordance with one or more implementations. Artificial reality device package 100a illustrates a top view of the packaging such that a device can be placed directly into or on top of the molding 106a. Artificial reality device package 100b illustrates a side view of the packaging. Hereafter, the artificial reality device package 100a and 100b are collectively referred to as “packaging 100.” The packaging 100 may include one or more of an outer portion 102a and 102b (hereafter, collectively referred to as “outer portion 102”), an inner portion 104a and 104b (hereafter, collectively referred to as “inner portion 104”), a molding 106a and 106b (hereafter, collectively referred to as “molding 106”), a receiving portion 108a and 108b (hereafter, collectively referred to as “receiving portion 108”), a connecting portion 110a and 110b (hereafter, collectively referred to as “connecting portion 110”), and/or other components.

The outer portion 102 may serve as the external structure of the package charging station. The outer portion 102 may be constructed from materials such as cardboard, plastic, or other suitable packaging materials. It may be shaped to accommodate the inner portion 104 and protect the contents during shipping and handling. The outer portion 102 may have a design that allows it to be easily opened and closed for access to the artificial reality device.

The inner portion 104 may be designed to fit within the outer portion 102 and may include a contoured surface to support the artificial reality device. The inner portion 104 may be made from a foam or molded plastic that snugly fits the contours of the artificial reality device. It may provide stability to the artificial reality device when it is placed inside the packaging. The inner portion 104 may be removable from the outer portion 102 for ease of access to the artificial reality device.

The molding 106 may correspond to the shape of the artificial reality device and may be part of the inner portion 104 to provide a secure fit for the device. The molding 106 may be custom-designed for specific models of artificial reality devices to ensure a precise fit. It may prevent movement of the artificial reality device within the packaging, which could otherwise lead to damage. The molding 106 may have cutouts or recesses to accommodate various parts of the artificial reality device, such as lenses or buttons.

The receiving portion 108 may be located on the molding 106 and may be positioned to align with the charging port of the artificial reality device. The receiving portion 108 may be a recess or a built-in connector that matches the charging port on the artificial reality device. It may allow for a direct connection between the artificial reality device and the charging mechanism without the need for additional cables. The receiving portion 108 may be designed to accommodate different types of charging ports, such as USB-C or Micro-USB.

The connecting portion 110 may be integrated into the outer portion 102 and may be configured to connect to an external power source for charging the artificial reality device. The connecting portion 110 may include a cable with a plug that fits into a standard electrical outlet. It may provide a pathway for electrical current to reach the receiving portion 110 and charge the artificial reality device. The connecting portion 110 may be retractable or detachable to allow for easy storage when not in use. Examples of the connecting portion 110 may include various types of connectors, such as USB-C, lightning, or Micro-USB connectors, depending on the requirements of the artificial reality device.

The artificial reality device package 100 may function as an integrated system where the outer portion 102, inner portion 104, molding 106, receiving portion 108, and connecting portion 110 operate in conjunction to charge the artificial reality device. The outer portion 102 may house the inner portion 104, which in turn may hold the artificial reality device securely in place within the molding 106. The receiving portion 108 may engage with the charging port of the artificial reality device, and the connecting portion 110 may facilitate the connection to an external power source. When the artificial reality device is placed within the inner portion 104, the alignment of the receiving portion 108 with the device's charging port may allow for an efficient charging process.

The artificial reality device package 100 may utilize the inherent protective qualities of the packaging materials to safeguard the artificial reality device during the charging process. The inner portion 104 may act as a buffer between the artificial reality device and the outer portion 102, while the molding 106 may ensure that the device remains stationary and aligned with the receiving portion 108. The connecting portion 110 may be designed to be unobtrusive and may be concealed within the outer portion 102 when not in use, maintaining the aesthetic integrity of the packaging. The design of the connecting portion 110 may be versatile, accommodating various power sources and outlet types, while the receiving portion 108 may be adaptable to different artificial reality device models and their respective charging port configurations.

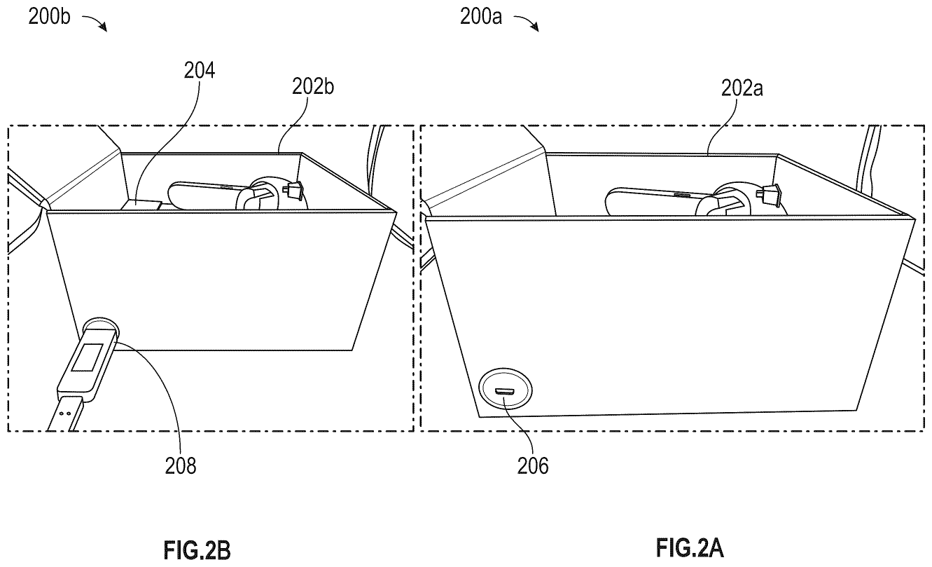

FIGS. 2A-2B illustrate an exemplary side-view illustration of an artificial reality headset packaging, in accordance with one or more implementations. The artificial reality headset packaging 200a and 200b (hereafter, collectively referred to as “packaging 200”) may include one or more of an outer portion 202a and 202b (hereafter, collectively referred to as “outer portion 202”), an inner portion 204, a connecting portion 206, a USB-C receiver 208, and/or other components.

The outer portion 202 may serve as the external structure of the artificial reality headset packaging 200. The outer portion 202 may be shaped to accommodate the inner portion 204 and any additional components necessary for the charging station's function. The inner portion 204 may be designed to fit within the outer portion 202 and hold the artificial reality device securely. In some implementations, the inner portion 204 may be removable for ease of access or replacement.

The connecting portion 206 may be included in the outer portion 202 and configured to connect to an external power source. In some implementations, the connecting portion 206 may include a built-in transformer to regulate the power supplied to the artificial reality device. The USB-C receiver 208 may be part of the connecting portion 206 and facilitate the connection between the charging cable and the artificial reality headset packaging 200.

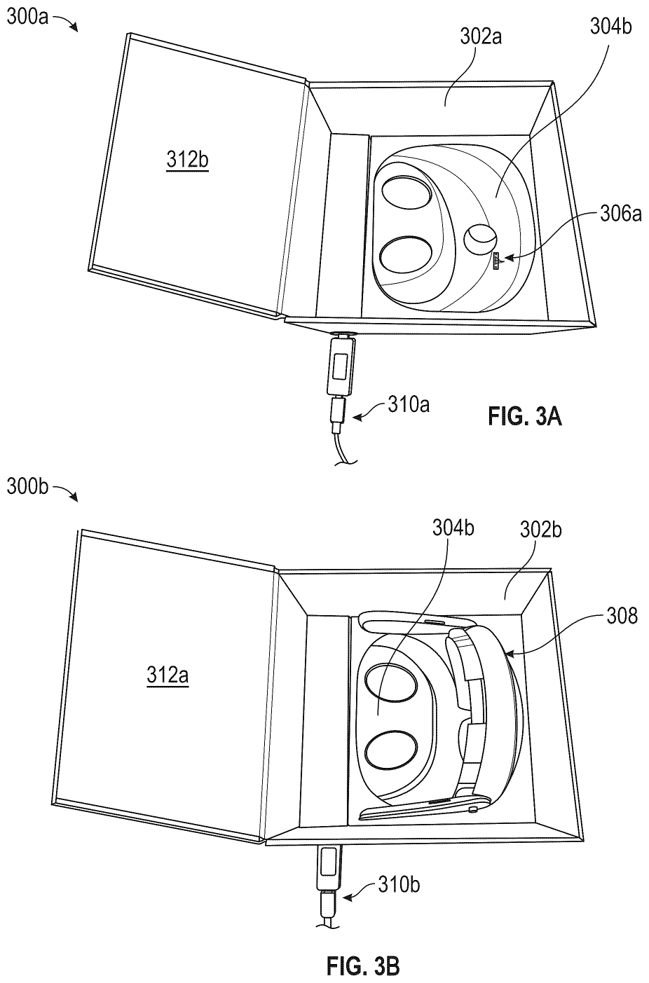

FIGS. 3A-3B illustrate a top view of the artificial reality headset packaging (see, e.g., artificial reality headset packaging 200 of FIG. 2), in accordance with one or more implementations. The artificial reality headset packaging 300a is an illustration of the packaging without a device placed therein. The artificial reality headset packaging 300b is an illustration of the packaging with an artificial reality device 308 placed therein. The artificial reality headset packaging 300a and 300b (hereafter, collectively referred to as “packaging 300”) may include one or more of an outer packaging 302a and 302b (hereafter, collectively referred to as “outer packaging 302”), an inner packaging 304a and 304b (hereafter, collectively referred to as “inner packaging 304”) comprising a molding for a device, pogo pin ports 306, a cable 310, and/or other components. In some implementations, the packaging 300 may include a lid 312a and 312b (hereafter, collectively referred to as “lid 312”) attached to the outer packaging 302.

The outer packaging 302 may serve as the external structure for the artificial reality device packaging 300. The outer packaging 302 may have a shape and size configured to accommodate the inner packaging 304 and the artificial reality device 308. The inner packaging 304 may be designed to securely hold the artificial reality device 308 within the outer packaging 302. The inner packaging 304 may be a molded insert that conforms to the shape of the artificial reality device 308, providing stability and reducing movement during transport.

The pogo pin ports 306 may provide electrical connections to the artificial reality device 308 when it is placed within the inner packaging 304. The pogo pin ports 306 may consist of spring-loaded pins that make contact with corresponding pads on the artificial reality device 308 to establish a charging connection. The pogo pin ports 306 may be positioned within the inner packaging 304 to align with the charging contacts on the artificial reality device 308 when it is seated properly.

The artificial reality device 308 may be the primary device intended for use with the artificial reality device packaging 300. The artificial reality device 308 may include features such as lenses, sensors, and electronic components that allow for an immersive artificial reality experience. The artificial reality device 308 may interface with the pogo pin ports 306 to receive power for charging. The cable 310 may connect the artificial reality device 308 to a power source for charging purposes. The cable 310 may be a USB cable with a connector compatible with the artificial reality device 308 or the outer packaging 302. The cable 310 may be detachable or permanently affixed to the outer packaging 302.

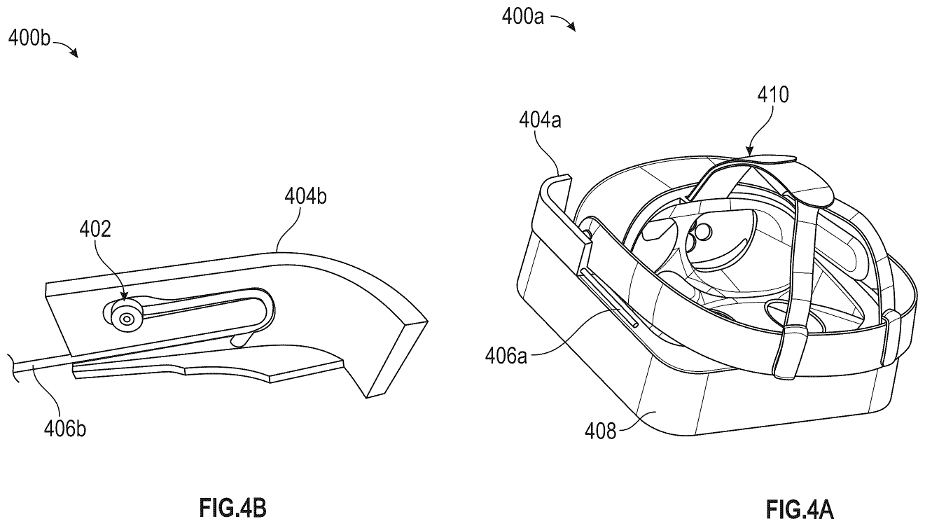

FIGS. 4A-4B illustrate an exemplary aspects of a magnetic charging station, in accordance with one or more implementations. The magnetic charging station 400a may include one or more of a clip 404a, a magnetic cable 406a, an inner packaging 408, a headset 410, and/or other components. In some implementations, the headset 410 may include one or more accessories, for example, a head strap (illustrated in FIG. 4), frame, or the like. magnetic charging station 400b is a zoomed in version of the magnetic connection including a magnetic receiver 402, the clip 404b, and the magnetic cable 406b.

The magnetic receiver 402 may be configured to attach to a charging connector or port of an artificial reality device. The magnetic receiver 402 may be part of a package modification kit that can be applied to existing artificial reality device packaging. The magnetic receiver 402 may serve as the interface between the artificial reality device and the charging source. In some implementations, the magnetic receiver 402 may be designed to accommodate various types of charging connectors, such as USB-C or Micro-USB.

The clip 404a and 404b (hereafter, collectively referred to as “clip 404”) may be designed to secure the magnetic receiver 402 to the packaging of the device. The clip 404 may allow for easy attachment and detachment of the magnetic receiver 402 to the packaging. The clip 404 may be made from materials such as plastic or metal to provide a sturdy connection. In some implementations, the clip 404 may come in different sizes or shapes to fit various packaging designs.

The magnetic cable 406a and 406b (hereafter, collectively referred to as “magnetic cable 406”) may be magnetically attachable to a magnetic tip of the magnetic receiver 402. The magnetic cable 406 may facilitate the connection between the power source and the magnetic receiver 402 without the need for precise alignment. The magnetic cable 406 may include a retractable mechanism to keep the cable organized when not in use. In some implementations, the magnetic cable 406 may be available in different lengths to accommodate different charging setups.

The inner packaging 408 may be structured to support the artificial reality device in a specific orientation during charging. The headset 410 may be positioned to align with the magnetic receiver 402 when placed within the inner packaging 408. The headset 410 may include a built-in charging port that corresponds with the receiving portion of the magnetic receiver 402. The headset 410 may be designed to rest securely within the inner packaging 408 to maintain the connection with the magnetic receiver 402.

In some implementations, the magnetic charging station 400 may be designed to utilize the existing packaging of the artificial reality device, transforming it into a functional charging station. This approach may leverage the protective features of the packaging to provide a stable and secure charging environment for the headset 410. The integration of the charging station into the packaging may reduce the need for additional charging accessories, simplifying the charging process for the user.

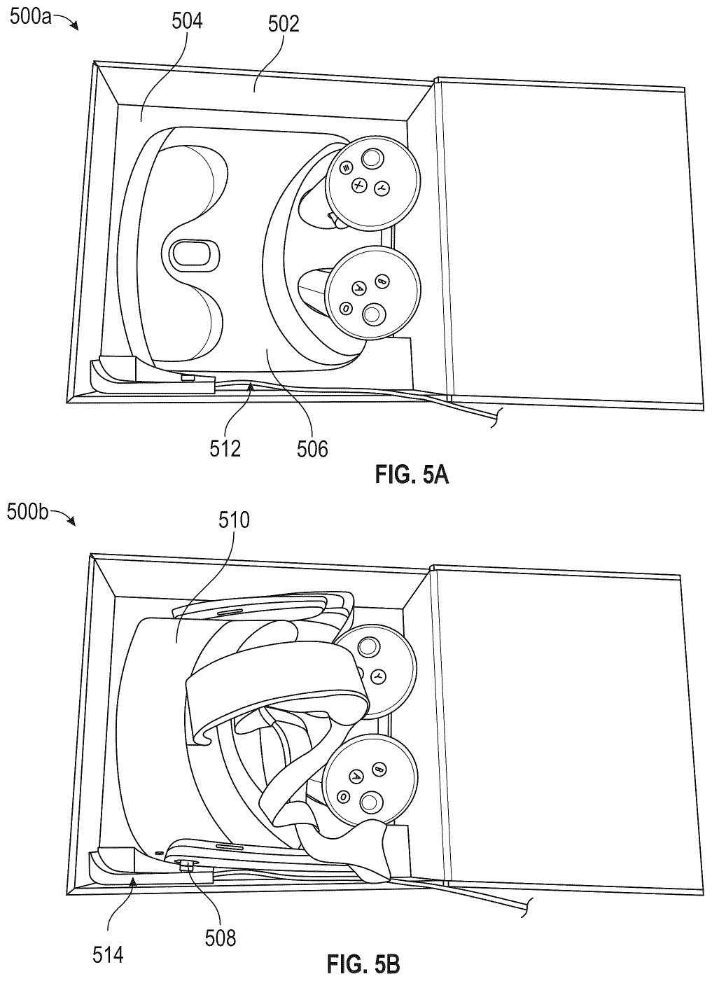

FIGS. 5A and 5B illustrate an example artificial reality device packaging 500a without an artificial reality headset connected to a magnetic connector-based charging station and an example artificial reality device packaging 500b with an artificial reality headset connected to a magnetic connector-based charging station, respectively, in accordance with one or more implementations. The artificial reality device packaging 500 may include one or more of an outer portion 502, an inner portion 504, a molding 506, a receiving portion 508, an artificial reality device 510, a magnetic cable 512, a magnetic charging clip 514, and/or other components.

The outer portion 502 may serve as the external structure of the artificial reality device packaging 500. The outer portion 502 may have a shape and size that is suitable for containing the inner portion 504 and any additional components necessary for the packaging and charging of the artificial reality device 510. The inner portion 504 may be designed to securely hold the artificial reality device 510 within the outer portion 502. The inner portion 504 may be a contoured surface or insert that matches the shape of the artificial reality device 510 to prevent movement and reduce the risk of damage during transport or storage. The molding 506 may correspond to the shape of the artificial reality device 510 to provide a snug fit within the inner portion 504. The receiving portion 508 may be positioned to align with the charging port of the artificial reality device 510 when placed within the molding 506.

The artificial reality device 510 may be the primary hardware to be charged and used in conjunction with the artificial reality device packaging 500. The artificial reality device 510 may include components such as a display, sensors, and control interfaces that allow users to interact with virtual environments. The artificial reality device 510 may be designed to fit within the inner portion 504 and connect to the receiving portion 508 for charging. The artificial reality device 510 may come in various forms, such as headsets, glasses, or handheld controllers, each with its own specific design and charging requirements.

The magnetic cable 512 may connect to a power source and provide the means for transferring electrical power to the artificial reality device 510. The magnetic charging clip 514 may facilitate the attachment of the magnetic cable 512 to the artificial reality device 510 for charging purposes. The magnetic charging clip 514 may be a component that is attached to the inner portion 504 or the molding 506 and aligns with the charging port of the artificial reality device 510. An illustrative example of the magnetic charging clip 514 may be a small magnetic dock that is built into the packaging and connects to the artificial reality device 510 when it is placed inside.

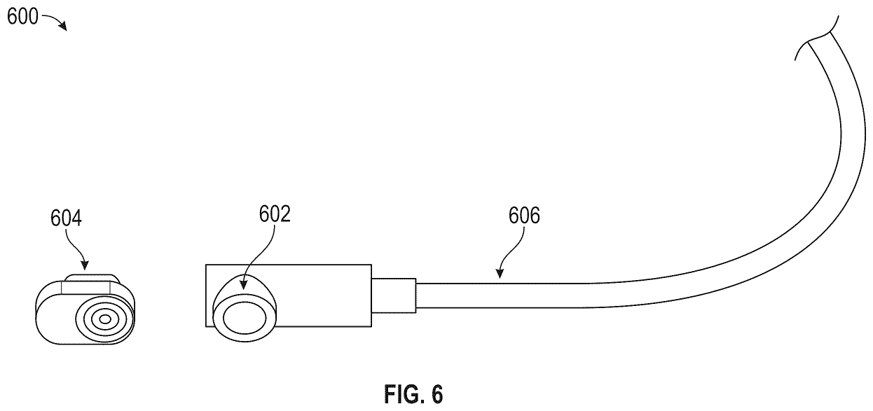

FIG. 6 illustrates a magnetic cable design 600 used as part of a magnetic connector-based charging station, in accordance with one or more implementations. The magnetic cable design 600 may include one or more of a power port 602, a magnetic receiver 604, a magnetic charging cable 606, and/or other components.

The power port 602 may be configured to connect to the device for charging purposes. The power port 602 may be part of the magnetic cable design 600 and may serve as the interface between the device and the charging source. The power port 602 may be designed to fit securely with the corresponding charging connector on the artificial reality device. In some implementations, the power port 602 may be a USB-C or Micro-USB port, which are common charging standards for artificial reality devices.

The magnetic receiver 604 may include a port that is attachable to a charging connector of the artificial reality device. The magnetic receiver 604 may allow for a secure and convenient connection to the artificial reality device without the need for precise alignment. The magnetic receiver 604 may interact with the power port 602 to complete the charging circuit when the artificial reality device is placed in proximity. In some implementations, the magnetic receiver 604 may be equipped with a magnetic tip that snaps into place with a corresponding magnetic adapter on the artificial reality device.

The magnetic charging cable 606 may be magnetically attachable to the magnetic receiver 604 to facilitate the charging process. The magnetic charging cable 606 may provide the flexibility to easily connect and disconnect from the magnetic receiver 604. The magnetic charging cable 606 may carry the electrical current from the power source to the magnetic receiver 604, which then transfers the power to the artificial reality device. In some implementations, the magnetic charging cable 606 may come in various lengths and may feature a braided design for enhanced durability.

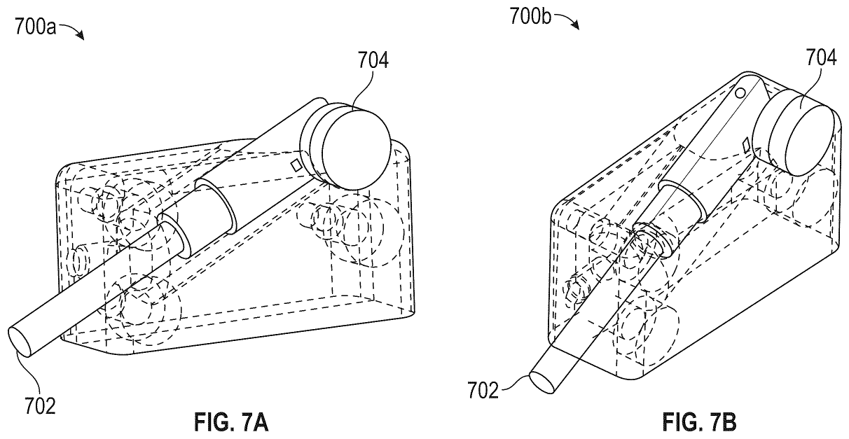

FIGS. 7A and 7B illustrate an exemplary magnetic charger design 700a and 700b at two different angles, in accordance with one or more implementations. The magnetic charger design 700 may include one or more of a cable 702, a magnetic receiver 704, and/or other components. The cable 702 may be used to connect the package charging station to an external power source. The cable 702 may be of a length sufficient to reach from the package charging station to a wall outlet or other power source. The magnetic receiver 704 may be part of the charging mechanism, allowing for easy attachment and detachment of the artificial reality device for charging. The magnetic receiver 704 may include a magnetic tip that aligns with a corresponding magnetic connector on the artificial reality device to establish an electrical connection for charging.

In some examples of the device packaging charging stations and related kits and methods described herein, the outer portion may include a box or packaging of an artificial reality device.

In some examples of the device packaging charging stations and related kits and methods described herein, the outer portion may hold the inner portion.

In some examples of the device packaging charging stations and related kits and methods described herein, the outer portion may include a cover or lid.

In some examples of the device packaging charging stations and related kits and methods described herein, a cable may be connected to a power source at a first end of the cable, and the cable may be connected to the outer portion via the connecting portion at a second end of the cable to commence charging of the artificial reality device.

In some examples of the device packaging charging stations and related kits and methods described herein, the connecting portion may include at least one of a USB-C, lightning, or Micro-USB receiver/connector.

In some examples of the device packaging charging stations and related kits and methods described herein, the receiving portion may be at least one of a pogo pin receiver or female USB-C (port).

In some examples of the device packaging charging stations and related kits and methods described herein, the connecting portion may be a magnetic connector configured to attach and detach to the magnetic receiver.

In some examples of the device packaging charging stations and related kits and methods described herein, the magnetic receiver may be attached to a magnetic cable via the magnetic tip.

In some examples of the device packaging charging stations and related kits and methods described herein, the cable may be connected to an adapter connected to the power source.

Some examples of the device packaging charging stations and related kits and methods described herein may include a package modification kit comprising a magnetic receiver and a magnetic charging cable.

In some examples of the device packaging charging stations and related kits and methods described herein, the package modification kit may further include an attachment means to attach the package modification kit to a packaging or a stand of the artificial reality device.

In some examples of the device packaging charging stations and related kits and methods described herein, the magnetic receiver may be attachable to the artificial reality device, and the magnetic charging cable may be configured to magnetically connect to the magnetic receiver to facilitate charging.

In some examples of the device packaging charging stations and related kits and methods described herein, the inner portion may further comprise a contoured surface designed to align with and support specific features of the artificial reality device.

In some examples of the device packaging charging stations and related kits and methods described herein, the molding may include a recessed area configured to receive and hold the artificial reality device in a predetermined orientation for charging.

In some examples of the device packaging charging stations and related kits and methods described herein, the connecting portion may comprise a retractable mechanism to store the cable when not in use, maintaining an organized appearance.

In some examples of the device packaging charging stations and related kits and methods described herein, the receiving portion may include an indicator that displays the charging status of the artificial reality device.

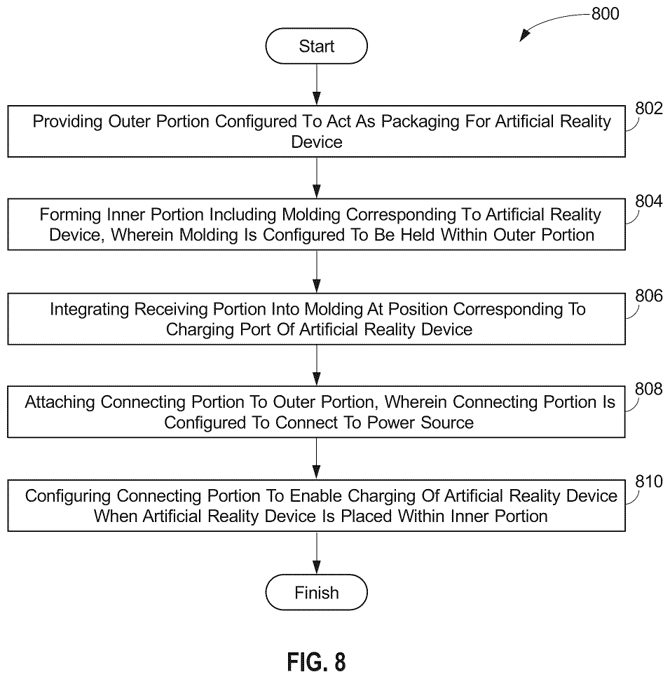

FIG. 8 illustrates an example method (e.g., process 800) for manufacturing a device packaging charging station, in accordance with one or more implementations. For explanatory purposes, the example process 800 is described herein with reference to FIGS. 1-7. Further for explanatory purposes, the steps of the example process 800 are described herein as occurring in serial, or linearly. However, multiple instances of the example process 800 may occur in parallel.

At 802, the process 800 may include providing an outer portion configured to act as packaging for an artificial reality device. At 804, the process 800 may include forming an inner portion including a molding corresponding to the artificial reality device, wherein the molding is configured to be held within the outer portion. At 806, the process 800 may include integrating a receiving portion into the molding at a position corresponding to a charging port of the artificial reality device. At 808, the process 800 may include attaching a connecting portion to the outer portion, wherein the connecting portion is configured to connect to a power source. At 810, the process 800 may include configuring the connecting portion to enable charging of the artificial reality device when the artificial reality device is placed within the inner portion.

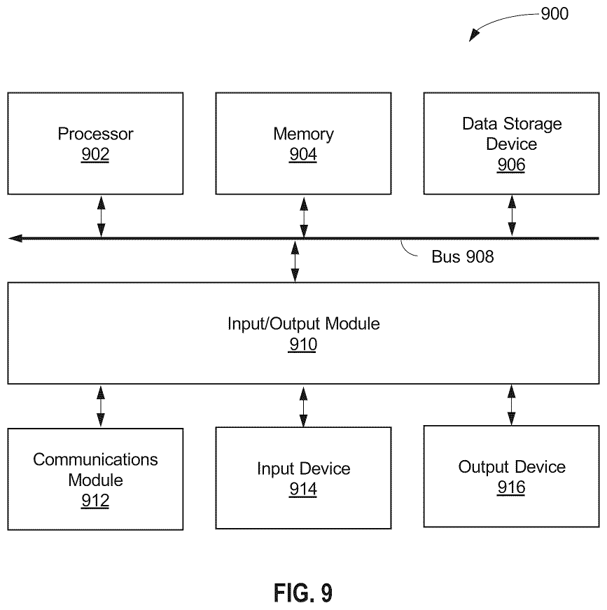

FIG. 9 is a block diagram illustrating an exemplary computer system 900 with which aspects of the subject technology can be implemented. In certain aspects, the computer system 900 may be implemented using hardware or a combination of software and hardware, either in a dedicated server, integrated into another entity, or distributed across multiple entities.

Computer system 900 (e.g., server and/or client) includes a bus 908 or other communication mechanism for communicating information, and a processor 902 coupled with bus 908 for processing information. By way of example, the computer system 900 may be implemented with one or more processors 902. Processor 902 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 900 can include, in addition to hardware, code that creates an execution environment for the computer program in question, e.g., code that constitutes processor firmware, a protocol stack, a database management system, an operating system, or a combination of one or more of them stored in an included memory 904, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 908 for storing information and instructions to be executed by processor 902. The processor 902 and the memory 904 can be supplemented by, or incorporated in, special purpose logic circuitry.

The instructions may be stored in the memory 904 and implemented in one or more computer program products, i.e., one or more modules of computer program instructions encoded on a computer-readable medium for execution by, or to control the operation of, the computer system 900, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 904 may also be used for storing temporary variable or other intermediate information during execution of instructions to be executed by processor 902.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 900 further includes a data storage device 906 such as a magnetic disk or optical disk, coupled to bus 908 for storing information and instructions. Computer system 900 may be coupled via input/output module 910 to various devices. The input/output module 910 can be any input/output module. Exemplary input/output modules 910 include data ports such as USB ports. The input/output module 910 is configured to connect to a communications module 912. Exemplary communications modules 912 include networking interface cards, such as Ethernet cards and modems. In certain aspects, the input/output module 910 is configured to connect to a plurality of devices, such as an input device 914 and/or an output device 916. Exemplary input devices 914 include a keyboard and a pointing device, e.g., a mouse or a trackball, by which a user can provide input to the computer system 900. Other kinds of input devices 914 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 916 include display devices such as an LCD (liquid crystal display) monitor, for displaying information to the user.

According to one aspect of the present disclosure, the above-described gaming systems can be implemented using a computer system 900 in response to processor 902 executing one or more sequences of one or more instructions contained in memory 904. Such instructions may be read into memory 904 from another machine-readable medium, such as data storage device 906. Execution of the sequences of instructions contained in the main memory 904 causes processor 902 to perform the process steps described herein. One or more processors in a multi-processing arrangement may also be employed to execute the sequences of instructions contained in memory 904. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 900 can include clients and servers. A client and server are generally remote from each other and typically interact through a communication network. The relationship of client and server arises by virtue of computer programs running on the respective computers and having a client-server relationship to each other. Computer system 900 can be, for example, and without limitation, a desktop computer, laptop computer, or tablet computer. Computer system 900 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 902 for execution. Such a medium may take many forms, including, but not limited to, non-volatile media, volatile media, and transmission media. Non-volatile media include, for example, optical or magnetic disks, such as data storage device 906. Volatile media include dynamic memory, such as memory 904. Transmission media include coaxial cables, copper wire, and fiber optics, including the wires that comprise bus 908. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 900 reads game data and provides a game, information may be read from the game data and stored in a memory device, such as the memory 904. Additionally, data from the memory 904 servers accessed via a network the bus 908, or the data storage 906 may be read and loaded into the memory 904. Although data is described as being found in the memory 904, it will be understood that data does not have to be stored in the memory 904 and may be stored in other memory accessible to the processor 902 or distributed among several media, such as the data storage 906.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A package charging station, comprising:
an outer portion;
an inner portion including a molding corresponding to an artificial reality device;
a receiving portion included in the molding at a position corresponding to a charging port of the artificial reality device; and
a connecting portion included in the outer portion configured to connect to power for charging the artificial reality device when the artificial reality device is placed in the inner portion.

2. The package charging station of claim 1, wherein the outer portion includes a box or packaging of an artificial reality device.

3. The package charging station of claim 1, wherein the outer portion includes a cover or lid.

4. The package charging station of claim 1, wherein a cable is connected to a power source at a first end of the cable, and wherein the cable is connected to the outer portion via the connecting portion at a second end of the cable to commence charging of the artificial reality device.

5. The package charging station of claim 1, wherein the receiving portion is at least one of a pogo pin receiver or female port.

6. The package charging station of claim 1, wherein the connecting portion is a magnetic connector configured to attach and detach to the magnetic receiver, and the magnetic receiver is attached to a magnetic cable via the magnetic tip.

7. The package charging station of claim 1, wherein the cable is connected to an adapter connected to the power source.

8. The package charging station of claim 1, wherein the inner portion is made of a durable material capable of supporting the receiving portion, wherein the durable material includes one or more of a plastic, a metal, or a composite material.

9. The package charging station of claim 1, further comprising a package modification kit including a magnetic receiver and a magnetic charging cable, wherein the magnetic receiver is attachable to the artificial reality device, and wherein the magnetic charging cable is configured to magnetically connect to the magnetic receiver to facilitate charging.

10. The package charging station of claim 1, wherein the inner portion further comprises a contoured surface designed to align with and support specific features of the artificial reality device.

11. The package charging station of claim 1, wherein the molding includes a recessed area configured to receive and hold the artificial reality device in a predetermined orientation for charging.

12. The package charging station of claim 1, wherein the connecting portion comprises a retractable mechanism to store the cable when not in use, maintaining an organized appearance.

13. The package charging station of claim 1, wherein the receiving portion includes an indicator that displays the charging status of the artificial reality device.

14. A method for charging in a packaging charging station, comprising:
receiving an artificial reality device in a molding set in an inner portion of a packaging charging station;
receiving, at a receiving portion included in the molding, a connection signal from a charging port of the artificial reality device, a position of the receiving portion corresponding to the charging port of the artificial reality device; and
charging the artificial reality device based on the connection signal, wherein the inner portion is fixed inside of an outer portion of the packaging charging station, the outer portion connecting the packaging charging station to power for charging the artificial reality device.

15. The method of claim 14, wherein charging the artificial reality device further comprises: receiving power from a cable connected to a power source at a first end of the cable, and wherein the cable is connected to the outer portion via a connecting portion at a second end of the cable to commence the charging of the artificial reality device.

16. The method of claim 14, wherein the receiving portion is at least one of a pogo pin receiver or female port.

17. The method of claim 14, wherein the inner portion is made of a durable material capable of supporting the receiving portion, wherein the durable material includes one or more of a plastic, a metal, or a composite material.

18. The method of claim 14, wherein the inner portion is made of a durable material capable of supporting the receiving portion, wherein the durable material includes one or more of a plastic, a metal, or a composite material.

19. The method of claim 14, wherein the inner portion further comprises a contoured surface designed to align with and support specific features of the artificial reality device.

20. A method for manufacturing a device packaging charging station, comprising:
providing an outer portion configured to act as packaging for an artificial reality device;
forming an inner portion including a molding corresponding to the artificial reality device, wherein the molding is configured to be held within the outer portion;
integrating a receiving portion into the molding at a position corresponding to a charging port of the artificial reality device;
attaching a connecting portion to the outer portion, wherein the connecting portion is configured to connect to a power source; and
configuring the connecting portion to enable charging of the artificial reality device when the artificial reality device is placed within the inner portion.
